(19) United States
(12) Patent Application Publication
(10) Pub. No.: US 2007/0003653 A1
(43) Pub. Date: Jan. 4, 2007

(54) Automated manufacturing device and method for biomaterial fusion

(76) Inventors: Karen Marie Ahle, Manhattan Beach, CA (US); Brooke C. Basinger, Scottsdale, AZ (US); Cyndia A. Sweet, The Dalles, OR (US); Benjamin Charles Martin, Quincy, MA (US); Elizabeth Whitney Johansen, Somerville, MA (US); Jason De Camp, Fremont, CA (US); Kenton W. Gregory, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 11/059,640

(22) Filed: Feb. 15, 2005

Related U.S. Application Data
(63) Continuation-in-part of application No. 10/132,079, filed on Apr. 24, 2002, now Pat. No. 6,855,139.
(63) Continuation-in-part of application No. 10/104,391, filed on Mar. 21, 2002.

(51) Int. Cl. B29C 35/08

(52) U.S. Cl. 425/174.4; 623/920

(57) ABSTRACT

An apparatus for making a bioprosthetic stent graft is disclosed, the stent having a stent frame and a biomaterial sheath suturelessly bonded to the stent frame. An automated energy irradiator guidance system is disclosed which reduces the potential for human error and improves the consistency and repeatability of tissue welding techniques. The system includes a mapper, a patternizer, an energy director and can additionally include an energy regulator. An interface is included, allowing pattern creation, selection and editing by a user. The system further provides control of energy irradiator parameters for use in tissue welding.

### CROSS REFERENCE TO RELATED APPLICATIONS

This application is a continuation-in-part of and claims priority from each of U.S. Ser. No. 10/132,079, filed on Apr. 24, 2002, and U.S. Ser. No. 10/104,391, filed on Mar. 21, 2002, the subject matter of which are incorporated by reference for all purposes.

This invention was made with U.S. Government support under Grant Number DAMD17-96-6006, awarded by the Army Medical Research and Materiel Command. The U.S. Government may have certain rights in the invention.

### BACKGROUND OF THE INVENTION

The present invention is related to the field of stents, and more specifically to a stent device and method for automated sutureless biomaterial bonding in the manufacture of such stents.

Tissue closure is most commonly performed using sutures, which are inexpensive, reliable, and readily available. Unfortunately, sutures cause additional tissue damage during their placement and tying. Sutures also result in the introduction of a foreign material into the body, increasing the risk for further damage or rejection. Moreover, sutures do not necessarily result in a water tight seal and may require a long healing time. The placement of sutures involves a complicated set of movements that may be difficult of impossible in microsurgical or minimally invasive applications.

Laser welding is the procedure of using focused laser energy to bond tissues or biomaterials together. The absorbed energy results in a molecular alteration of the affected biomaterial and causes bonds to form between neighboring biomaterials. Laser soldering is a method of improving biomaterial welding by introducing a proteinaceous solder material between the biomaterial or other surfaces to be joined prior to exposure to the laser. Soldering is beneficial for its ability to enhance bond strength, lessen collateral damage, and enlarge the parameter window for a successful bond. The solder is able to do this by holding the biomaterials together creating a larger bonding surface area, sometimes by as much as two degrees of magnitude.

Laser welding has been used successfully in nerve, skin, and arterial applications, as well as on biomaterials such as elastin and collagen. The technique offers significant advantages for securing and sealing skin grafts, repairing solid-tissue organ damage, minimizing laceration trauma, and closing surgical incisions.

Welding typically uses an 800 nm-range laser in conjunction with a chromophore (e.g., indocyanine green (ICG)) to essentially heat, denature and fuse together skin, organ tissues, or biomaterial. Current welding techniques are highly dependent on the individual skill and technique of the operator. Welding processes require the operator to determine the appropriate dose of laser energy, then manually apply irradiation by directly manipulating an optical fiber handpiece. Accurate determination of optimal laser parameters is difficult in this model. Furthermore, manual control of laser positioning and movement can, and often does, lead to under or overexposure of tissues/biomaterials to laser energy which can cause failed welds.

The success of welding techniques can vary greatly due to manual laser control. The variation in technique among operators makes accurate research difficult, if not impossible, and the lack of standardized irradiation patterns and dosages only adds to the inconsistency of welding procedural success. For laser welding to reach its full potential, it must become a more consistent and repeatable process.

Prosthetic stents and valves have been used with some success to overcome the problems of restenosis or re-narrowing of a vessel wall. However, the use of such devices is often associated with thrombosis and other complications. Additionally, prosthetic devices implanted in vascular vessels can exacerbate underlying atherosclerosis.

Medical research therefore has focused on trying to incorporate artificial materials or biocompatible materials as bioprosthesis coverings to reduce the untoward effects of metallic device implantation, such as intimal hyperplasia, thrombosis and lack of native tissue incorporation.

Biomaterials and biocompatible materials also have been utilized in prostheses. Such attempts include a collagen-coated stent, taught in U.S. Pat. No. 6,187,039 (to Hiles et al.). As well, elastin has been identified as a candidate biomaterial for covering a stent (U.S. Pat. No. 5,990,379 (to Gregory)). In contrast to synthetic materials, collagen-rich biomaterials are believed to enhance cell repopulation and therefore reduce the negative in vivo effects of metallic stents. It is believed that small intestinal submucosa (SIS) is particularly effective in this regard. Accordingly, it is desirable to employ a native biomaterial or a biocompatible material to reduce post-procedural complications.

Mechanically hardier stent graft devices are required in certain implantation sites, such as cardiovascular, aortic, or other locations. In order to produce a sturdier bioprosthetic stent, a plurality of layers of biomaterial typically are used. Suturing is a poor technique for joining multiple layers of biomaterial. While suturing is adequate to join the biomaterial sheets to the metallic frame, the frame-sutured multiple sheets are not joined on their major surfaces and are therefore subject to leakage between the layers. Suturing of the major surfaces of the biomaterial layers also introduces holes into the major surfaces, increasing the risk of conduit fluid leaking through or a tear forming in one of the surfaces.

Heretofore, biomaterials have been attached to bioprosthetic frames using conventional suturing techniques. However, this approach is disadvantageous from manufacturing and implantation perspectives. Suturing is time-consuming and labor-intensive. For example, suturing a sheet of biomaterial over a stent frame typically is a one- to two-hour process for a trained person and of the covered stents made, many are rejected. It is also an operator dependent process that can lead to issues with product uniformity and reliability. As well, suturing entails repeatedly piercing the biomaterial, creating numerous tiny punctures that can weaken the biomaterial and potentially lead to leakage and infection after the graft device has been installed. Moreover, the presence of suture material can enhance the foreign body response and lead to tubular vessel narrowing at the implantation site.

As an alternative to suturing, U.S. Pat. Nos. 5,147,514, 5,332,475, and 5,854,397 describe processes for photo-oxidizing collageneous material in the presence of a photo-catalyst to crosslink and stabilize the collageneous material. Reconstituted soluble collagen fibrils are taught to be mixed and suspended in solutions containing a photo-catalyst, so that a photo-oxidizative cross-linking process can be performed to produce stabilized collagen products.

However, the references fail to teach crosslinking of collagen fibrils between two individual collageneous materials, as well as fusion of those separate materials using photo-oxidization techniques.

### BRIEF DESCRIPTION OF THE DRAWINGS

FIG. 1 is a perspective view of a sutureless bioprosthetic stent graft constructed according to the method disclosed herein.

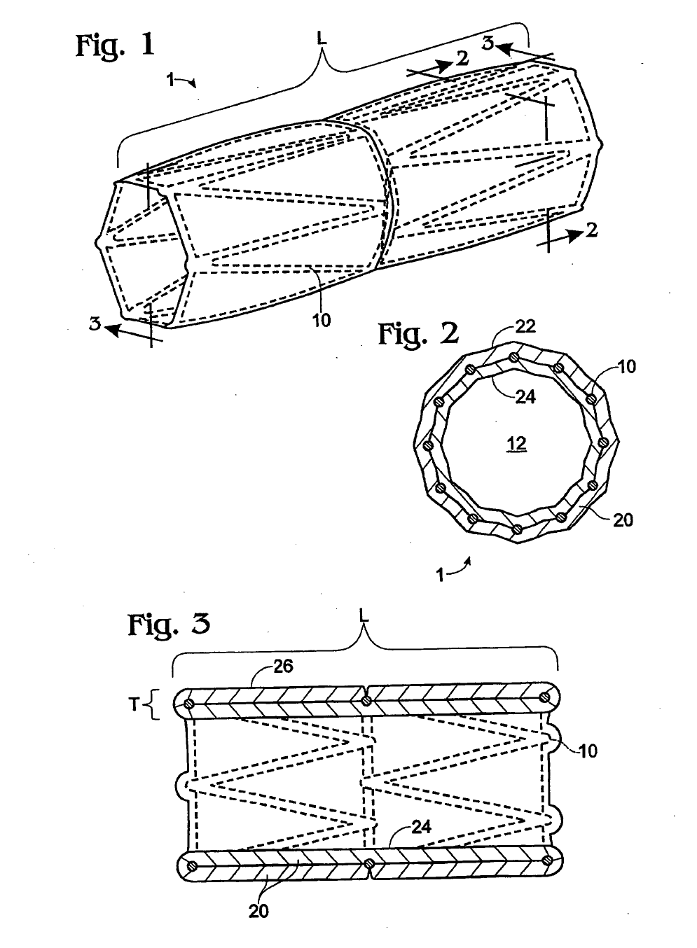

FIGS. 2-3 are lateral and longitudinal cross-sectional views, respectively, of the valve graft of FIG. 1.

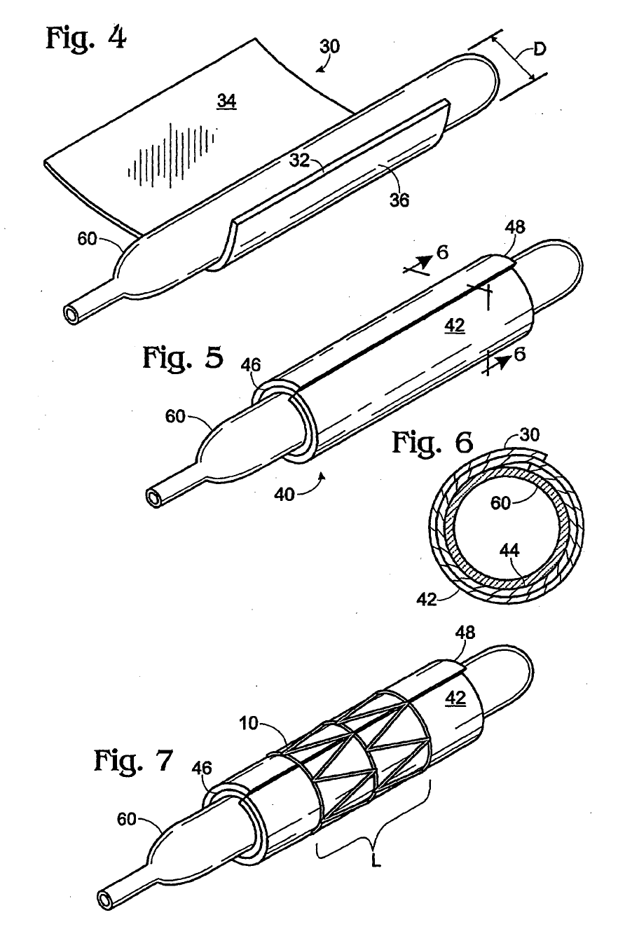

FIGS. 4-9 are diagrams of a method for constructing a sutureless bioprosthetic stent graft according to the present disclosure.

FIGS. 10-11 are side view diagrams of two embodiments of a device for manufacturing a sutureless bioprosthetic stent graft according to the disclosed method.

FIG. 12 is a cutaway perspective diagram of a mandrel of the present device, having housed therein means for irradiating with energy.

FIG. 13 is a block diagram of one embodiment of an automated welding system.

FIGS. 14-15 are alternative embodiments of the system of FIG. 13.

FIG. 16 is a block diagram of a system as disclosed herein, showing representative user inputs.

### DETAILED DESCRIPTION OF PREFERRED EMBODIMENT(S)

Implantable stents and grafts are disclosed in Applicant's U.S. Ser. No. 10/104,391. The stent graft 1 therein comprises a typically cylindrical stent frame 10 having a length L and defining a lumen 12. The stent graft further has a sheath of biomaterial 20 suturelessly attached to and substantially covering the stent frame.

The stent frame 10 preferably is constructed of a fine-gauge metal (e.g., 0.014 inch diameter) of a flexible character. Such frame enables the stent graft to be expanded or compressed in diameter or length.

The stent frame is covered with a biomaterial sheath 20 having a selected thickness T. The biomaterial sheath can comprise a single layer, a single layer with a partial overlap, or a plurality of layers (single or multiple sheets) coupled to the supporting stent frame. The sheath of biomaterial preferably comprises both the inner stent graft surface 24 and the outer stent graft surface 26.

If the biomaterial sheath is constructed of a plurality of layers of biomaterial, the plurality of layers of biomaterial can be positioned on the inner stent graft surface 24, the outer stent graft surface 26, or both inner and outer stent graft surfaces.

The biomaterial can be comprised of a natural or synthetic compound, and preferably is a collagen-rich material. Suitable natural biomaterials include collagen, small intestine submucosa, pericardial tissue, and elastin. Combinations of the above biomaterials also can be envisioned. Alternatively, the biomaterial can be synthetic, for example, TEFLON or DACRON coated with albumin or a collagen-containing substrate.

The biomaterial formed into a sheath is bonded to the stent frame without the use of conventional sutures. Avoidance of suture material mitigates the risk of a foreign body response by the host patient, a response that can lead to a narrowing of the tubular vessel in which the graft is implanted.

To make a first embodiment of a bioprosthetic stent graft, a collagen-rich biomaterial is wrapped on a mandrel to form a multi-layer structure thereon, and the multiple layers of the biomaterial are suturelessly bonded together. The method can be employed to produce a stent graft composed of a biomaterial and further comprising a synthetic stent frame.

In one embodiment of the method, a sheet of biomaterial 30 is provided, having a first edge 32, an inward-facing surface 34 and an outward-facing surface 36.

As stated above, the biomaterial sheet can be comprised of a natural or synthetic compound, and preferably is a collagen-rich material. The use of a reconstructed small intestine submucosa (SIS) is especially advantageous. Reconstructed SIS biomaterial can be obtained in accordance with the description in the prior U.S. Pat. Nos. 4,956,178 and 4,902,508.

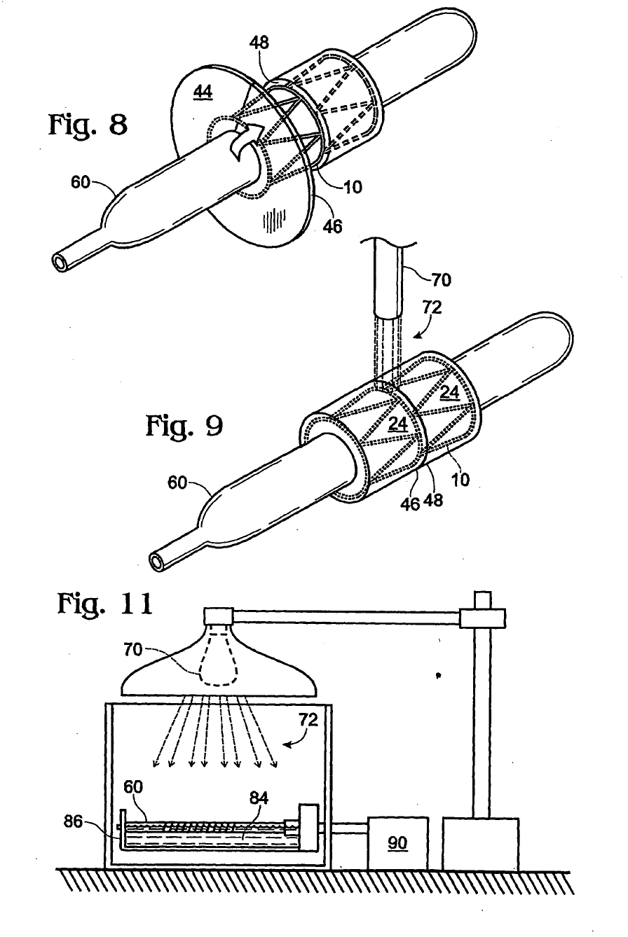

The biomaterial sheet 30 is wrapped on a mandrel 60 to form a biomaterial roll 40. As shown in FIGS. 4-5, wrapping can be performed by approximating the first edge 32 of the biomaterial sheet 30 longitudinally along the mandrel 60, then rotating the mandrel. Of course, it is also possible to immobilize the mandrel and wrap the biomaterial sheet around it.

As formed and shown in FIGS. 5-6, the biomaterial roll 40 has a first major surface 42, a second major surface 44, a first end 46, and a second end 48.

A stent frame 10 then is positioned over the first major surface 42 of the biomaterial roll 40 and intermediate the first and second ends 46,48 of the biomaterial roll (FIG. 7).

The stent frame is shown being encased with the biomaterial in FIG. 8. At least the first end 46 of the biomaterial roll 40 is everted back over the stent frame 10, covering and embedding it within the biomaterial roll. The first end 46 can be approximated, overlapped, or abutted to the first major surface 42 of the biomaterial roll proximate the second end 48.

In a first alternative embodiment shown in FIG. 8, the first end 46 and the second end 48 both can be everted and folded back over the stent frame to encase the frame in biomaterial. In this embodiment, the first end and the second end of the biomaterial roll can be approximated, overlapped, or abutted to one another.

In a second alternative embodiment, a second sheet of biomaterial can be laid over the stent frame to cover it and approximate, overlap, or abut the second biomaterial sheet with the first major surface of the biomaterial roll.

The biomaterial (i.e., the first end and the biomaterial roll to which it is approximated, overlapped, or abutted) is suturelessly bonded by irradiating with energy 72. In the embodiments wherein one or both ends of the biomaterial roll were everted, suturelessly bonding comprises suturelessly bonding the first and second ends of the biomaterial to one another or to the first major surface 42 of the biomaterial roll 40.

In a preferred embodiment, sutureless bonding is via thermal fusion. The biomaterial roll is irradiated with energy 72 sufficient to at least partially thermally fuse the biomaterial sheet. Sutureless bonding using thermal fusion preferably is carried out with a laser, most preferably emitting light having a wavelength of about 800 nm.

To facilitate thermal fusion and localize the thermal energy to the site of sutureless bonding, an energy-absorbing material can be utilized. For use with a laser, the energy-absorbing material typically is energy-absorptive within a predetermined range of light wavelengths. An energy-absorbing material suitable for use with an 800 nm laser is indocyanine green.

Sutureless bonding using an 800 nm laser can also be performed by laser welding, using tissue welding solder or patches. Tissue welding solder, known in the art, typically is a viscous proteinaceous fluid, such as an albumin solution. Welding patches can be dried strips of albumin, collagen, elastin, or similar compounds. The solder or welding patch can have incorporated therein an energy-absorbing material.

Sutureless bonding can be spatially limited to the approximated, overlapped, or abutted ends 46,48 of the biomaterial roll, but can also include irradiating selected loci on, or the entirety of, the first major surface 42, the second major surface 44, or both the first and second major surfaces 42,44 of the biomaterial roll 40.

Irradiating a plurality of loci on the biomaterial roll with energy can be facilitated by rotating the mandrel 60 during irradiating.

The suturelessly bonded biomaterial roll and encased stent frame then are removed from the mandrel. Removal generally is accomplished by sliding the stent graft 1 off the end of the mandrel 60. Alternatively, the mandrel can be of an expandable or balloon-type construction, and can be deflated to assist in stent graft removal.

A device is disclosed for manufacturing a sutureless bioprosthetic stent graft as previously described. The device generally comprises a mandrel 60 and an energy-irradiating means 70. In an alternative embodiment discussed below, the energy-irradiating means 70 and the mandrel 60 can be structurally combined.

In one embodiment as shown in FIGS. 4-5 and 7-9, the mandrel 60 preferably is a roughly cylindrical structure having a selected diameter D, adapted to have positioned on it a stent graft comprising a biomaterial sheath. The stent graft 1 fabricated thereon, described more fully above, typically has a shape matching the shape of the mandrel 60 and will have a lumen corresponding to the diameter D of the mandrel.

An automated energy irradiator guidance system 100 reduces the potential for human error and improves the consistency and repeatability of welding techniques in stent manufacture. The system includes an energy irradiator guidance system with an interface allowing pattern creation, selection and editing by a user. The system further includes a surface overlay display, and control of energy irradiator parameters for use in welding.

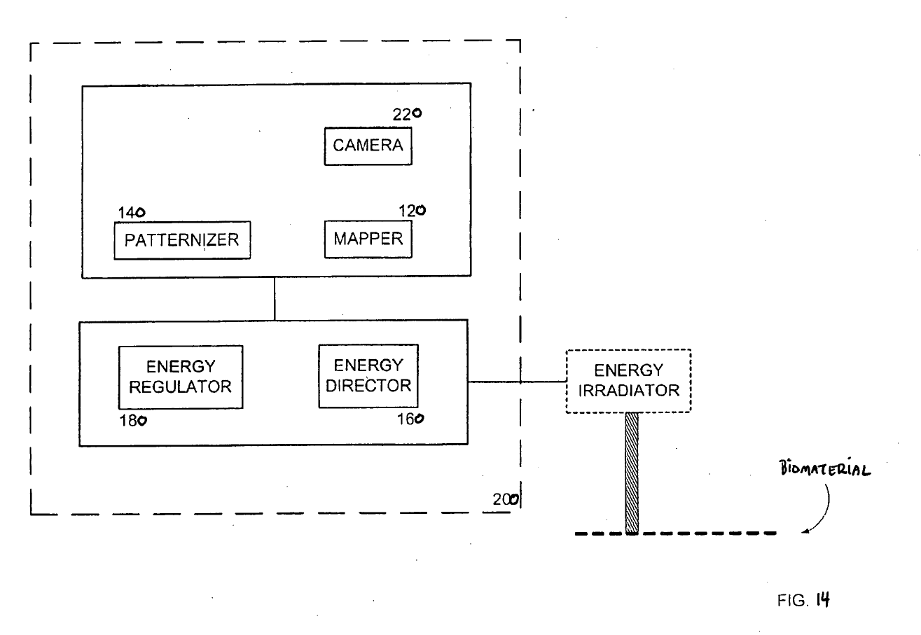

The system 100 can be used to perform welding at a target site. As shown in FIG. 13, the system 100 includes a mapper 120, a patternizer 140, an energy director 16 and can additionally include an energy regulator 180.

The energy irradiator (FIG. 13) typically is structured to deliver energy suitable for use in welding; as used in such welding, the energy irradiator usually comprises an energy transmitter coupled to an energy source. Welding typically involves localized heat generation by delivering energy to the target site. Light energy from an 800 nm laser is discussed herein; however, those of ordinary skill in the art will appreciate that other forms of energy can be efficaciously employed without departing from the essential principles of the present disclosure.

The mapper 120 is operative to generate a three-dimensional target site map of a target site. The target site on the biomaterial can be either two- or three-dimensional, although in most cases it will be the latter. In a preferred embodiment, the mapper is operative to generate a topographic target site map of the target site.

Physically, the weld site mapper 120 can include several different components, such as scanners, amplifiers, a power supply, circuit board, an internal computer driver card, and a variety of connecting cables.

The patternizer 140 is operative to synchronize an irradiating pattern with the target site map. In a preferred embodiment, the patternizer is operative to synchronize a two-dimensional irradiating pattern with a three-dimensional target site map. Such synchronization allows the user to implement a variety of irradiating patterns on the target site, regardless of the latter's topography.

The irradiating pattern can be a predetermined irradiating pattern. Alternatively, the irradiating pattern can be created by the user, either by combining predetermined patterns or by drawing an irradiating pattern on a display screen. The pattern typically consists of a plurality of irradiation targets, which can be correlated with an equivalent plurality of target loci at the weld site.

The energy director 160 is configured to substantially automatically direct the energy to the target site on a stent in accordance with the irradiating pattern. The energy director can act upon the energy irradiator directly or indirectly. For example, the energy director can comprise one or more motors configured to physically position the energy irradiator to thereby direct irradiated energy to a welding target locus. The director can be configured to automatically direct the energy irradiator in the X-axis and Y-axis, or in the X-axis, Y-axis and Z-axis.

In an indirect energy directing scheme, the energy director can comprise mirrors or other structure structured to direct the energy irradiated from the energy irradiator to the desired welding target locus. In an example in which a laser energy irradiator is employed, the energy director 160 can comprise one or more mirrors. The mirrors can be manipulated to deliver treatment to the target area, with the laser parameters selected and in the pattern chosen by the user.

The system described above can further comprise an energy regulator 18 adapted to regulate energy from the energy irradiator. In one embodiment, the energy regulator is adapted to cause the energy irradiator to deliver a selected amount of energy to an irradiation locus within the target site.

Alternatively, the energy regulator 180 is adapted to cause the energy irradiator to deliver selected amounts of energy to a plurality of irradiation loci at the target site. In another alternative embodiment, the energy regulator is adapted to cause the energy irradiator to deliver a selected amount of energy to each of a plurality of irradiation loci within the target site.

The energy regulator 180 can be an energy positioner configured to determine an energy irradiator position in the X-axis and Y-axis. Alternatively, the energy positioner can be configured to determine an energy irradiator position in the X-axis, Y-axis and Z-axis.

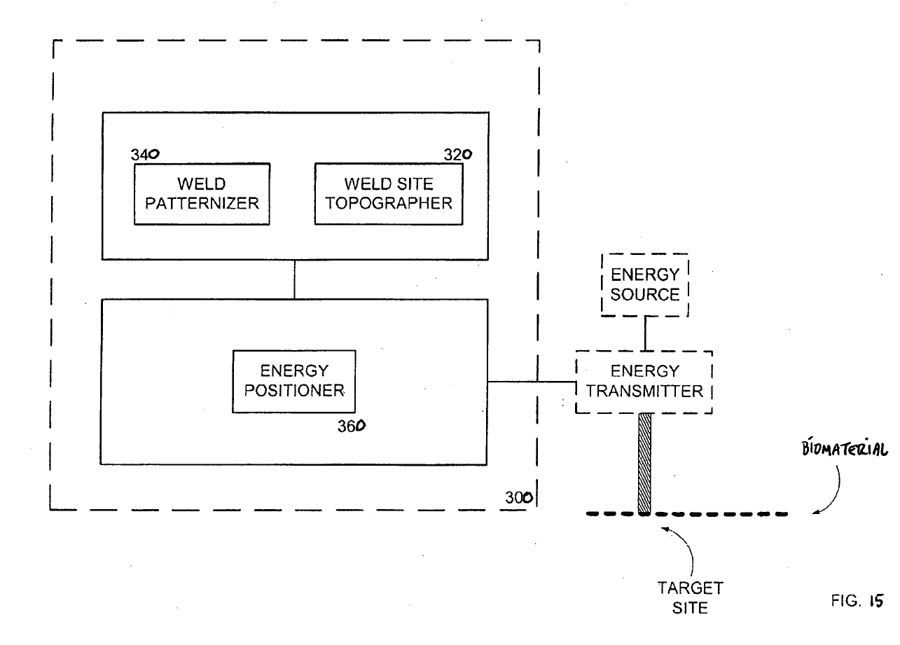

The system 200 shown in FIG. 14 further comprises a camera 220 adapted to output a site image of a targeted weld site. When so equipped, the mapper 120 is operative to generate a three-dimensional target site map from the site image outputted from the camera 220.

The energy regulator 180 can further be operative to correct for irradiating variables to deliver a substantially controlled irradiation dose to the weld site. Such irradiating variables include, for example, energy spot size and distance from the energy transmitter to a target point within the weld site.

A more simplified embodiment of a welding system 300 is shown in FIG. 15. As discussed above, the weld site topographer 320 is operative to generating a topographical image of the target site.

The weld patternizer 340 is operative to synchronize an irradiating pattern with a two-dimensional or a three-dimensional target site map. The irradiating pattern can also be either two-dimensional or three-dimensional.

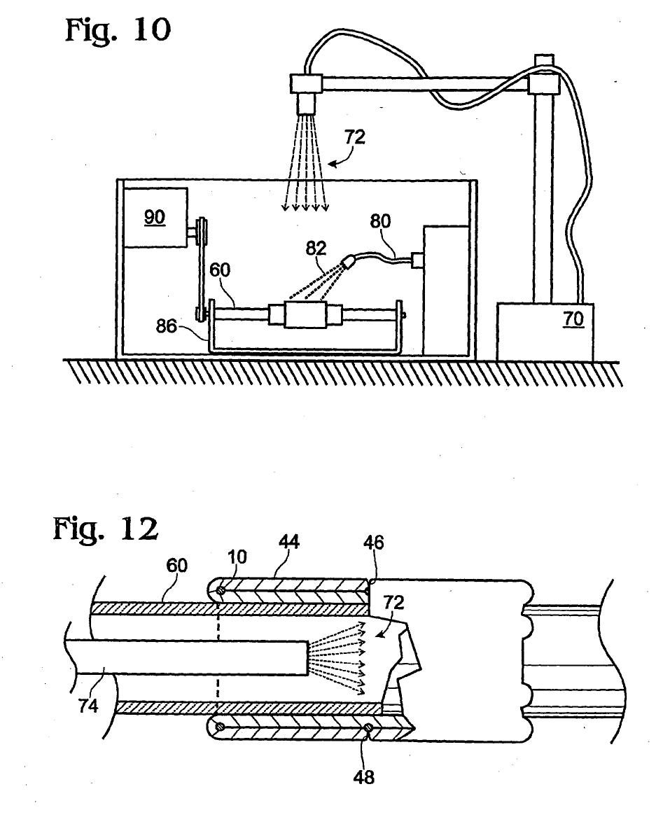

The automated energy irradiator guidance system 100 is adapted to irradiate a biomaterial sheath with energy 72 when the biomaterial sheath is positioned on the mandrel 60. Irradiation results in suturelessly bonding via a thermal bonding mechanism. In the embodiments of FIGS. 10-11, means for irradiating is configured to irradiate the first major surface 42 of a biomaterial roll 40 positioned on the mandrel 60.

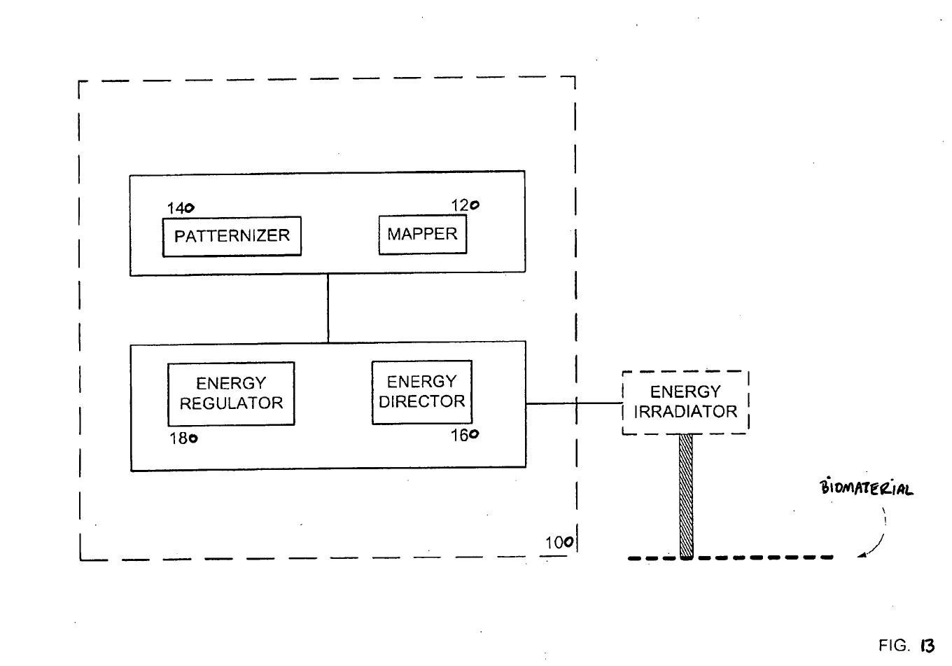

In another alternative embodiment, irradiation via the system 100 can be configured inside the mandrel 60 (FIG. 12). This configuration permits irradiation of the second major surface 44 of a biomaterial roll 40 positioned on the mandrel 60. An irradiating means inside the mandrel can be employed as an alternative to, or in addition to, an external irradiating means to permit irradiation of the second major surface or both the first and second major surfaces, respectively, of a biomaterial roll.

The device can further include means for moistening 80 a biomaterial sheath when said sheath is positioned on the mandrel. Moistening can be accomplished via an injecting or misting element 82 adapted to emit a mist of fluid or other appropriate moistening matter. Alternatively, fluid 84 can be maintained in a well 86, with the mandrel positioned above said fluid. So oriented, the lower-most portion of the biomaterial roll 40 on the mandrel will contact the fluid and be wetted thereby.

Rotating means 90 for rotating the mandrel 60 further can be utilized to rotate a stent graft positioned on the mandrel. Rotating enables the entire outward-facing (first major) surface 42 of the biomaterial sheath to be accessible to the moistening means 80. Rotation of the mandrel further permits the energy-irradiating means 70 to be directed to varying areas of the outward-facing surface of the biomaterial sheath. Rotating, whether continuous or coordinated with irradiating, is advantageous for irradiating specific loci on the outward-facing surface.

A method for automatically directing energy to a target site on a stent graft begins by generating a topographical target site image. The system is capable of topographically mapping a target site having a three-dimensional character, although two-dimensional welding sites can also be used.

An irradiation pattern is correlated with the topographical target site image. The irradiation patterns, discussed above, can consist of modifiable predetermined patterns or a custom pattern created by the user. Templates for stents of specific diameters can be pre-inputted into the system if desired.

Once the irradiation pattern is selected and correlated with the topographic image of the target site, irradiation energy is automatically introduced to the target site in accordance with the irradiation pattern. The system controls the delivery of energy to provide a selected dose to the target loci within the tissue welding site. System control of the energy, both as to strength, duration and position, improves the quality of the welding compared to manual techniques.

In operation, a user will properly prepare the system. Preparation generally includes proper placement of the device over the target area as well as powering up all equipment involved. This stage will not be discussed in detail at this point because it is not crucial to the design of the laser guidance system. It will, however, be assumed that this has been completed and the system is ready to be used.

Most user control over the system will be done through computer interaction. In one design, an image of the weld site can be displayed on, e.g., a computer monitor. The displayed image can be optical or thermal, according to the type of energy used and the user's preference.

The patternizer is configured to provide a plurality of templates (in this case, laser irradiation patterns) that can be overlaid on top of the weld image. A laser pattern can be resized or altered to better fit the application. It also is possible, in some embodiments, for the user to manually draw a pattern on the display, or to use a previous pattern from memory. If possible, other parameters may be controlled, including laser speed, delay time at each target locus, the number of desired cycles through the chosen pattern, and so on.

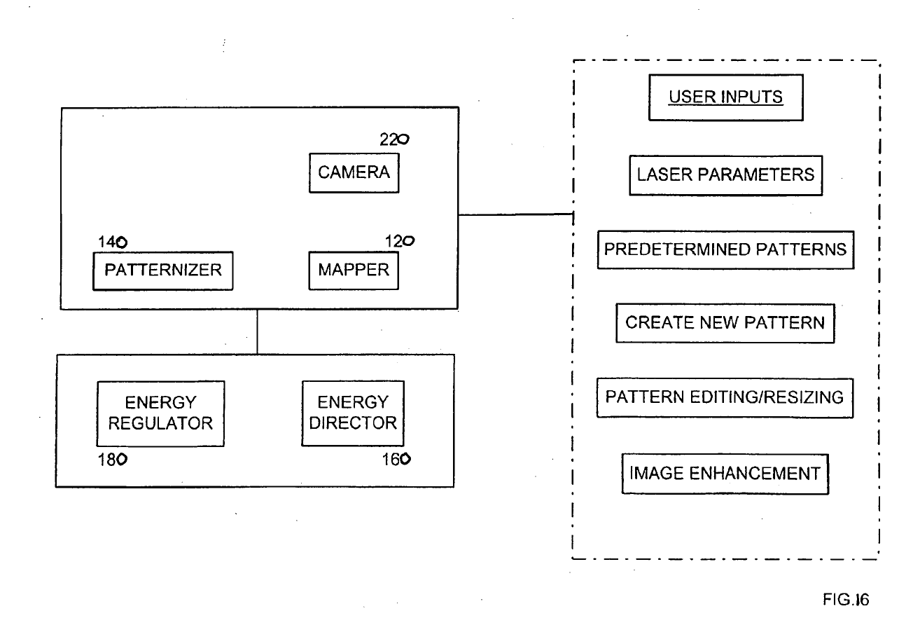

Laser parameters can also be controlled or adjusted (FIG. 16). For example, the system can allow manipulation of laser power, pulse width, frequency, and other parameters. These parameters typically can all be manually configured on the laser itself, providing both flexibility and a redundant feature for safety. User inputs to the system can be broken down into: pattern editing; creating; selecting; resizing; setting laser parameters; and manual image enhancement control.

Once the laser pattern has been determined and all laser parameters are set to the desired level, the system is ready to begin welding. The user instructs the system to begin, and the system will operate the laser to irradiate the target weld site according to the selected irradiating pattern.

The weld site image input first is enhanced and its edges detected, in order to establish a general pattern shape. This information is then displayed to the user for optional adjustment in a graphics editor. Finally, an irradiating pattern will be decomposed into vector format and converted to a scanner control signal.

A separate function is the laser parameter control, which accepts user input and communicates control signals to control the laser. The basic outputs of the system are a scanner control signal and a laser control signal.

The optics for a laser welding system include all necessary mirrors and lenses, as well as any protective windows that the laser passes through. The present system contemplates two mirrors, a protective window and a plurality of lenses.

The system can use a lens or series of lenses to expand and collimate the beam to a larger spot size before it enters the mirror assembly, thus reducing the intensity that is applied to the surface of the mirrors. The difficulty in this option is that any beam with a low enough intensity not to damage the mirrors may have too low an intensity to effectively weld together the target biomaterial. It is then necessary to focus the beam back down to a smaller beam size before it reaches the target tissue.

Beam focusing is preferably accomplished by using the initial set of lenses to produce a very long focal distance that will reach the mirrors while maintaining a “medium” spot size, yet have a smaller spot size and thus a larger intensity by the time it reaches the target biomaterial. This approach is calculated to produce a higher light intensity at the weld site than at the mirror surface.

It is theoretically impossible to focus the beam to an exact point; instead the beam will reach a minimum waist size before diverging. At longer focal lengths, that minimum achievable waist size becomes larger and larger, potentially reducing the beam's intensity at the irradiation site beyond the intensity necessary for effective welding.

A primary consideration of the camera is depth of field, i.e., the depth within which the camera must remain focused. To calculate the depth of field, both the furthest and closest points to the camera must be considered. Equation (4) relates these focal points to depth of field:
furthest distance−closest distance=depth of field (4)

For the present system, it is impracticable to directly center the camera on the path of the laser, because the laser beam will be obstructed. Hence, the other critical factor in determining depth of field is the displacement between the center of the target area and the placement of the camera. In equation (5), depth of field depends on the length, L, of the side of the square target area, the perpendicular distance, d, between the camera and the target area, and the displacement, x, between the center of the target area and the camera:
[(0.5L+d)²+(0.5L)²+d²]^{0.5}−d=depth of field (5)

Note that the depth of field quantity determined with a specific camera position in mind is no longer valid if the camera is moved to a position a different distance from the tissue. In this case, a new calculation must be performed. To ensure that the system will accommodate the most difficult depth of field case, calculations were performed using equation (5) with two different target area sizes (10×10 cm and 20×20 cm) and two different distances between the camera and target area (10 cm and 30 cm) (Table 2).

TABLE 2
Sample Camera Depth of Field Calculation

| L (cm) | d (cm) | x (cm) | depth of field (cm) |
|---|---|---|---|
| 10 | 10 | 2 | 3.2 |
| 20 | 10 | 2 | 8.6 |
| 10 | 30 | 2 | 1.2 |
| 20 | 30 | 2 | 3.8 |

The laser welding system herein described can weld a flat, square graft to a 10×10 cm piece of flat tissue from a distance of 10-30 cm. Optics are included that will support the selected energy irradiator, e.g., an 800 nm, pulsed diode laser of beam diameter ranging between 0.2 and 0.8 mm, maximum beam intensity approximately 10 kW/cm².

A person skilled in the art will be able to practice the present invention in view of the description present in this document, which is to be taken as a whole. Numerous details have been set forth in order to provide a more thorough understanding of the invention. In other instances, well-known features have not been described in detail in order not to obscure unnecessarily the invention.

While the invention has been disclosed in its preferred form, the specific embodiments thereof as disclosed and illustrated herein are not to be considered in a limiting sense. Indeed, it should be readily apparent to those skilled in the art in view of the present description that the invention can be modified in numerous ways. The inventor regards the subject matter of the invention to include all combinations and sub-combinations of the various elements, features, functions and/or properties disclosed herein.

What is claimed is:

1. A device adapted to manufacture a sutureless bioprosthetic stent graft, comprising:
a mandrel having a selected diameter and adapted to have positioned thereon a stent graft having a biomaterial sheath; and
an energy irradiation controller, including:
an energy irradiator,
a mapper operative to generate a three-dimensional target site map of a target site,
a patternizer operative to synchronize an irradiating pattern with the three-dimensional target site map, and
an energy director configured to substantially automatically direct energy from an energy irradiator to the target site in accordance with the irradiating pattern to weld together the biomaterial sheath.

2. The energy irradiation controller of claim 1 wherein the mapper is operative to generate a topographic target site map.

3. The energy irradiation controller of claim 1 wherein the patternizer is operative to synchronize a predetermined irradiating pattern with the three-dimensional target site map.

4. The energy irradiation controller of claim 1 wherein the patternizer is operative to synchronize a two-dimensional irradiating pattern with a three-dimensional target site map.

5. The energy irradiation controller of claim 1 wherein the energy director is configured to automatically direct the energy in the X-axis and Y-axis.

6. The energy irradiation controller of claim 1 wherein the energy director is configured to automatically direct the energy in the X-axis, Y-axis and Z-axis.

7. The energy irradiation controller of claim 1 wherein the energy irradiator includes an energy transmitter coupled to a energy source.

8. The energy irradiation controller of claim 1, further comprising an energy regulator adapted to regulate energy from the energy irradiator.

9. The energy irradiation controller of claim 8 wherein the energy regulator is adapted to cause the energy irradiator to deliver a selected amount of energy to an irradiation locus within the target site.

10. The energy irradiation controller of claim 8 wherein the energy regulator is adapted to cause the energy irradiator to deliver selected amounts of energy to a plurality of irradiation loci within the target site.

11. The energy irradiation controller of claim 8 wherein the energy regulator is adapted to cause the energy irradiator to deliver a selected amount of energy to each of a plurality of irradiation loci within the target site.

12. The energy irradiation controller of claim 8 wherein the energy regulator is operative to correct for irradiating variables to deliver a substantially controlled irradiation dose to a weld site.

13. The energy irradiation controller of claim 12 wherein irradiating variables include energy spot size.

14. The energy irradiation controller of claim 12 wherein irradiating variables include a distance from an energy transmitter to a target point within the weld site.

15. The energy irradiation controller of claim 1, further comprising a camera adapted to output a site image of a targeted weld site, and wherein the mapper is operative to generate a three-dimensional target site map from the site image.

16. The device of claim 1, further comprising means for moistening the biomaterial sheath of the stent structure when positioned on the mandrel.

17. The device of claim 1, further comprising means for rotating the mandrel.

18. The device of claim 1, wherein the energy irradiator is a laser.

19. The device of claim 18, wherein the laser is a diode laser operative at a wavelength of about 800 nm.

20. The device of claim 1, wherein the mandrel includes a fiber-optic element adapted to transmit light from a light source to an inward-facing surface of a biomaterial sheath positioned on the mandrel.

21. A sutureless bioprosthetic stent graft manufacturing apparatus, comprising:
a mandrel having a selected diameter and adapted to have positioned thereon a stent graft having a biomaterial sheath;
an automated tissue welding apparatus for welding tissue at a weld site, including:
a weld site topographer operative to generate a displayable topographical image of the weld site,
a weld patternizer operative to topographically synchronize an irradiating pattern with the topographical image,
an energy transmitter coupled to a energy source and structured to transmit energy from the energy source to a targeted tissue weld site to weld the biomaterial, and
an energy positioner configured to automatically control positioning of the energy to irradiate the weld site to weld the biomaterial in accordance with the irradiating pattern.

22. The apparatus of claim 21, further comprising a camera adapted to output a site image of a targeted weld site, wherein the weld site topographer is operative to generate a site topographical image from the site image.

23. The apparatus of claim 21, further comprising an energy controller operative to correct for irradiating variables to deliver a substantially controlled irradiation dose to the weld site.

24. The apparatus of claim 21 wherein the energy positioner is configured to determine an energy irradiator position in the X-axis and Y-axis.

25. The apparatus of claim 21 wherein the energy positioner is configured to determine an energy irradiator position in the X-axis, Y-axis and Z-axis.
